(19) United States
(12) Patent Application Publication
(10) Pub. No.: US 2025/0273379 A1
(43) Pub. Date: Aug. 28, 2025

(54) THREE-PHASE TOROIDAL TRANSFORMER

(71) Applicant: Hubbell Incorporated, Shelton, CT (US)

(72) Inventors: Salvador Marruffo, III, Mequon, WI (US); Adam Peterson, Wilmot, WI (US); Jean-Yves Schneider, Fox Point, WI (US)

(21) Appl. No.: 19/202,899

(22) Filed: May 8, 2025

Related U.S. Application Data
(63) Continuation of application No. 16/428,178, filed on May 31, 2019, now Pat. No. 12,300,413.
(60) Provisional application No. 62/678,415, filed on May 31, 2018.

(51) Int. Cl. H01F 27/24; H01F 27/02; H01F 27/28; H01F 27/32; H01F 41/06

(52) U.S. Cl. CPC H01F 27/24; H01F 27/02; H01F 27/2823; H01F 27/32; H01F 41/06

(57) ABSTRACT

A three-phase transformer configured to transform a three-phase voltage. The transformer includes first, second, and third toroidal transformers. The first toroidal transformer is configured to transform a first phase of the three-phase voltage. The second toroidal transformer is electrically connected to the first toroidal transformer. The second toroidal transformer is configured to transform a second phase of the three-phase voltage. The third toroidal transformer is electrically connected to the first toroidal transformer and the second toroidal transformer. The third toroidal transformer is configured to transform a third phase of the three-phase voltage.

### RELATED APPLICATIONS

This application claims priority to U.S. patent application Ser. No. 16/428,178, filed May 31, 2019, which claims priority to U.S. Provisional Patent Application No. 62/678,415, filed on May 31, 2018, the entire contents of both of which are incorporated herein by reference.

### FIELD

Embodiments relate to voltage transformers.

### SUMMARY

Voltage transformers, such as low voltage transformers, may utilize distributed gap cores, mitered cores, strip steel cores, or stamped lamination cores as the magnetic core construction. However, such core constructions may be relatively large and heavy.

Thus, one embodiment provides a three-phase transformer configured to transform a three-phase voltage. The transformer includes first, second, and third toroidal transformers. The first toroidal transformer is configured to transform a first phase of the three-phase voltage. The second toroidal transformer is electrically connected to the first toroidal transformer. The second toroidal transformer is configured to transform a second phase of the three-phase voltage. The third toroidal transformer is electrically connected to the first toroidal transformer and the second toroidal transformer. The third toroidal transformer is configured to transform a third phase of the three-phase voltage.

Another embodiment provides a method of transforming a three-phase voltage. The method includes transforming, via a first toroidal transformer, a first phase of the three-phase voltage. The method further includes transforming, via a second toroidal transformer electrically connected to the first toroidal transformer, a second phase of the three-phase voltage. The method further includes transforming, via a third toroidal transformer electrically connected to the first toroidal transformer and the second toroidal transformer, a third phase of the three-phase voltage.

Other aspects of the application will become apparent by consideration of the detailed description and accompanying drawings.

### BRIEF DESCRIPTION OF THE DRAWINGS

FIG. 1 is a perspective view of a transformer according to some embodiments.

FIG. 2 is a perspective view of the transformer of FIG. 1 with a housing wall removed for illustrative purposes according to some embodiments.

FIG. 3 is a perspective view of the transformer of FIG. 1 with a housing wall and a cover removed for illustrative purposes according to some embodiments.

FIG. 4 is a perspective view of the transformer of FIG. 1 with housing walls and a cover removed for illustrative purposes according to some embodiments.

FIG. 5 is a side view of the transformer of FIG. 4 according to some embodiments.

FIG. 6 is a perspective view of a first phase transformer of the transformer of FIG. 1 according to some embodiments.

FIG. 7 is a perspective view of a first phase transformer of the transformer of FIG. 1 according to some embodiments.

FIG. 8 is a perspective view of a first phase transformer and a second phase transformer of the transformer of FIG. 1 according to some embodiments.

FIG. 9 is a perspective view of a first phase transformer, a second phase transformer, and a third phase transformer of the transformer of FIG. 1 according to some embodiments.

FIG. 10 is a block diagram of the transformer of FIG. 1 according to some embodiments.

FIG. 11 is flowchart illustrating an operation, or method, of the transformer of FIG. 1 according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

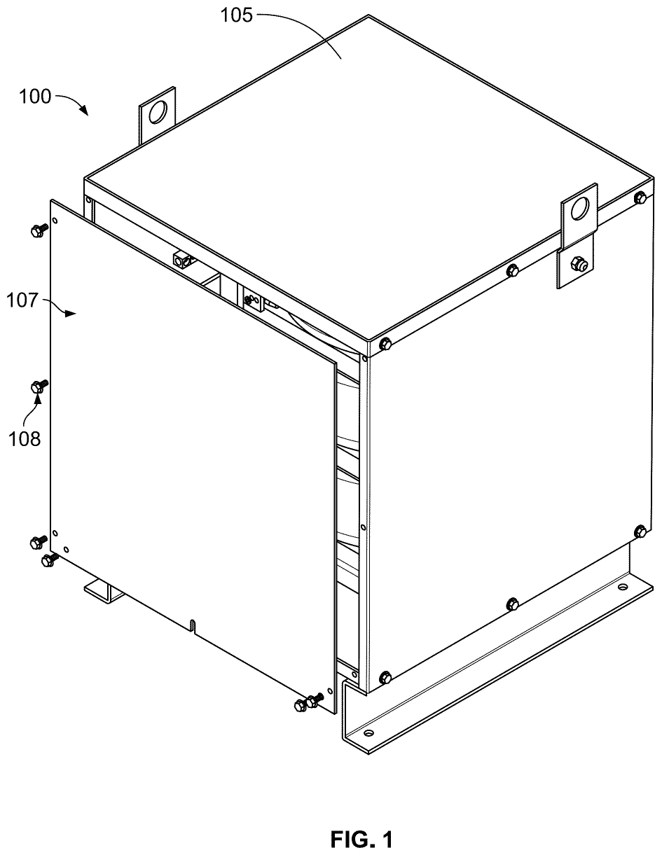

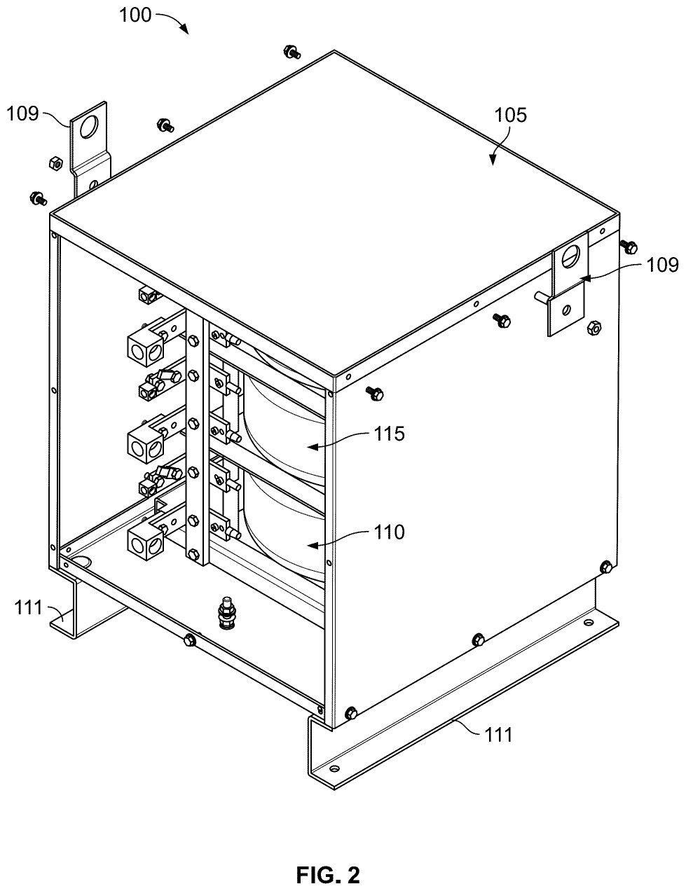

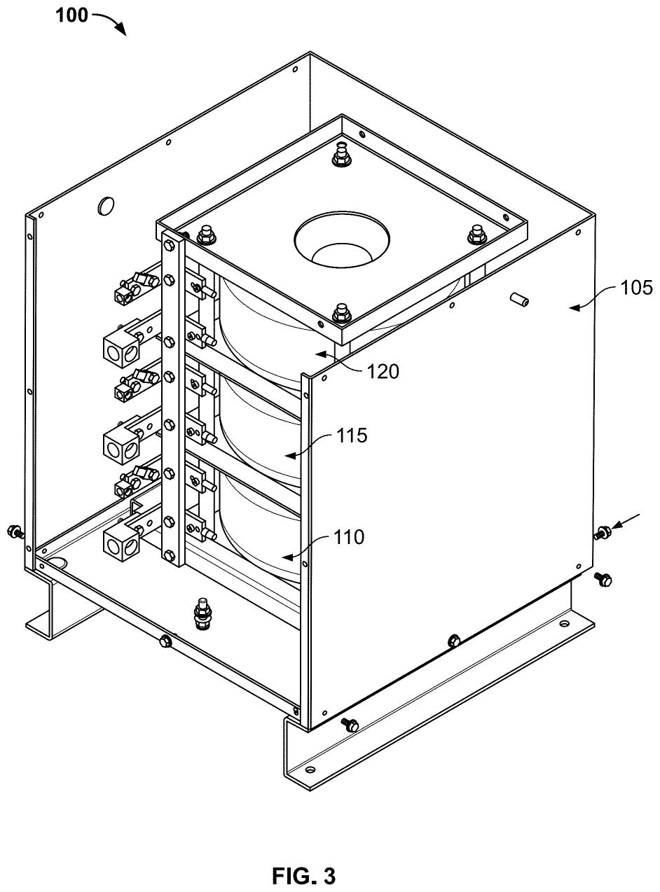

FIGS. 1-3 are perspective views of a transformer 100 according to some embodiments. Transformer 100 may be configured to transform a three-phase voltage from a first voltage to a second voltage. The transformer 100 includes a housing 105. In some embodiments, the housing 105 is formed of metal, such as but not limited to, sheet metal or a similar material. The housing 105 may include one or more walls 107 connected via one or more fasteners 108. In some embodiments, the housing 105 may be a wall-mounted housing (for example, via mounts 109). In other embodiments, the housing 105 may be a floor-mounted housing (for example, via mounts 111). Enclosed within the housing 105 are a first phase transformer 110, a second phase transformer 115, and a third phase transformer 120. Although illustrated as being placed in a vertical orientation, in other embodiments, the first phase transformer 110, the second phase transformer 115, and the third phase transformer 120 may be placed in a variety of orientations, including but not limited to, a horizontal orientation, a side-by-side orientation, and a staggered orientation.

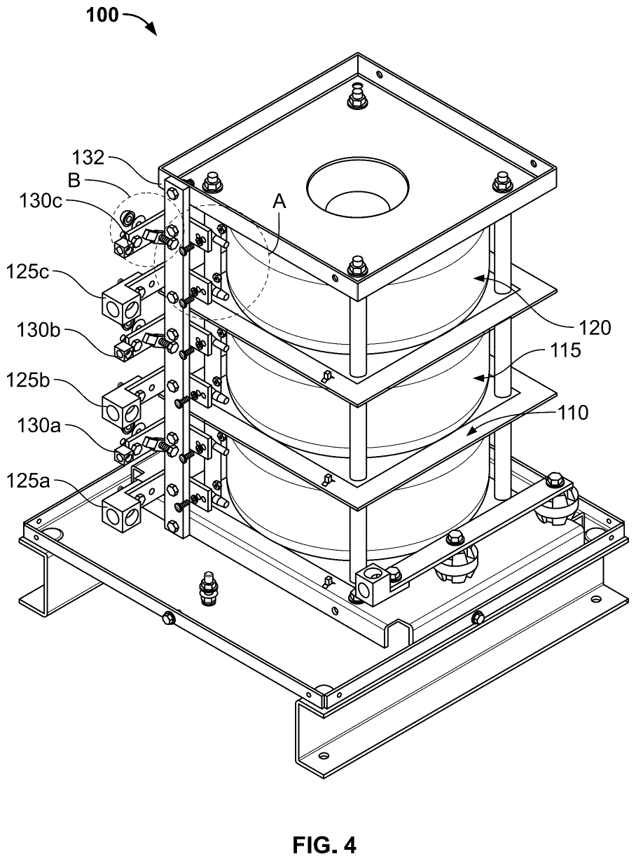

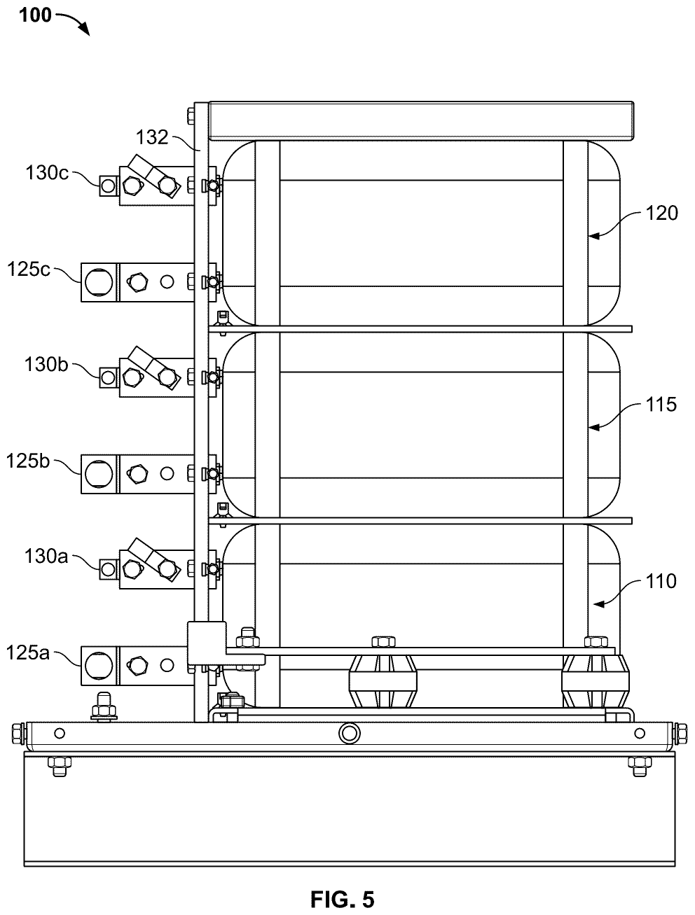

FIGS. 4 and 5 illustrate the first phase transformer 110, the second phase transformer 115, and the third phase transformer 120. As illustrated, in some embodiments, the first phase transformer 110, the second phase transformer 115, and the third phase transformer 120 may be stacked upon each other. Such an embodiment has the benefit of reducing the overall size of the housing 105, and thus the transformer 100.

As illustrated, each transformer 110, 115, 120 includes respective phase inputs 125a-125c and respective phase outputs 130a-130c. As illustrated, phase inputs 125a-125c and phase outputs 130a-130c may be supported by an input/output support 132. In general operation, the first phase transformer 110 is configured to receive a first phase, via the first phase input 125a, of a three-phase voltage at a first voltage and output the first phase, via the first phase output 130a, of the three-phase voltage at a second voltage. The second phase transformer 115 is configured to receive a second phase, via the second phase input 125b, of the three-phase voltage at the first voltage and output the second phase, via the second phase output 130b, of the three-phase voltage at the second voltage. The third phase transformer 120 is configured to receive a third phase, via the third phase input 125c, of the three-phase voltage at the first voltage and output the third phase, via the third phase output 130c, of the three-phase voltage at the second voltage.

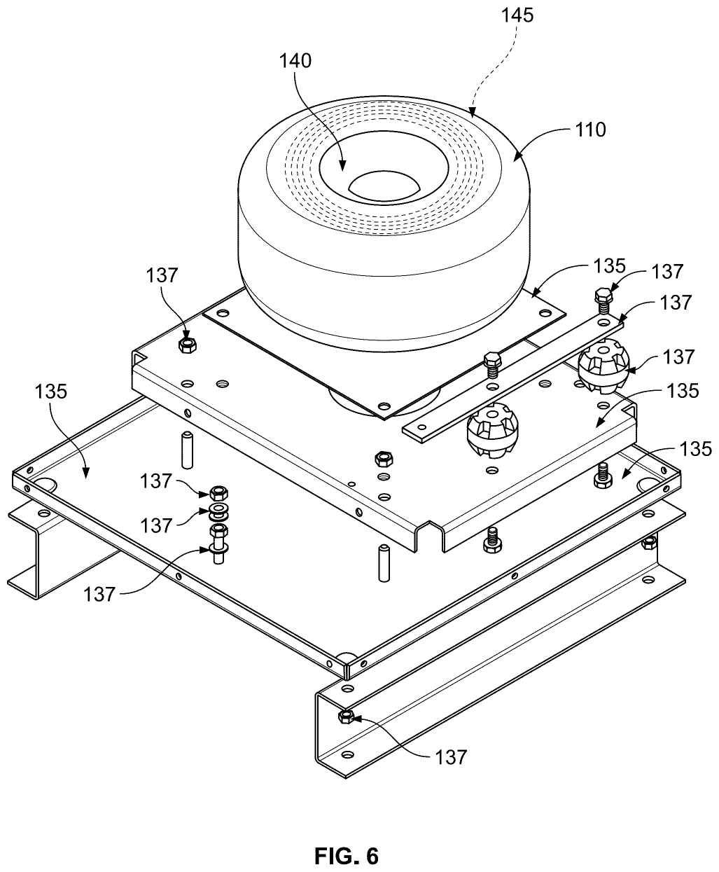

FIG. 6 illustrates an exploded view of the first phase transformer 110 and a base 135 according to some embodiments. The first phase transformer 110 is supported by the base 135. As illustrated, in some embodiments, the base 135 may be formed of one or more components. In some embodiments, the first phase transformer 110 is supported by the base 135 via one or more fasteners 137. The first phase transformer 110 may include a core 140 and a plurality of windings 145 wound around the core 140. In the illustrated embodiment, the core 140 has a toroidal shape. However, in other embodiments, the core 140 may have other shapes. In some embodiments, the plurality of windings 145 are wrapped magnet wire. In other embodiments, the plurality of windings 145 are film coated magnet wire. In some embodiments, the plurality of windings 145 are formed of aluminum, copper, or a similar material. As discussed above, in operation, the first phase transformer 110 is configured to receive the first phase of the three-phase voltage, and transform the first phase from the first voltage to the second voltage.

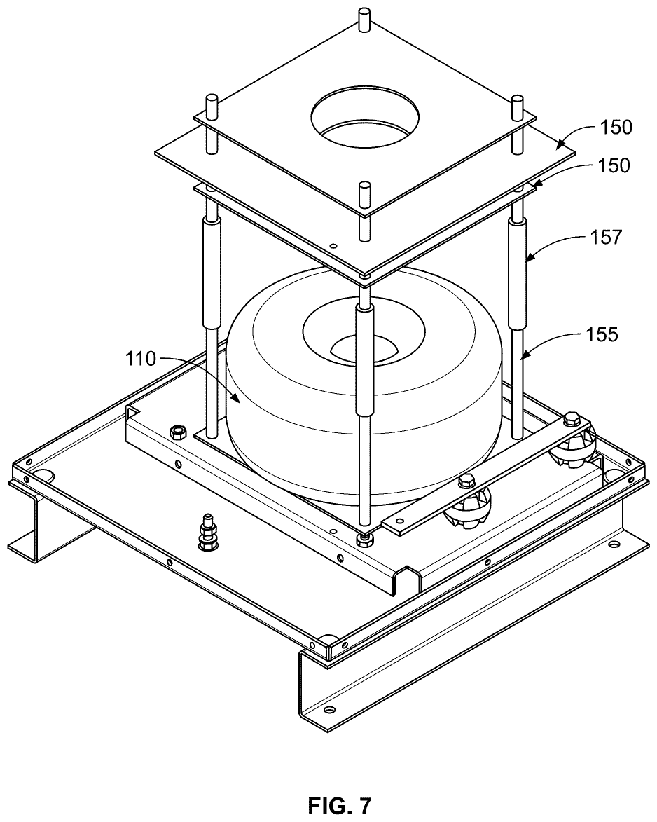

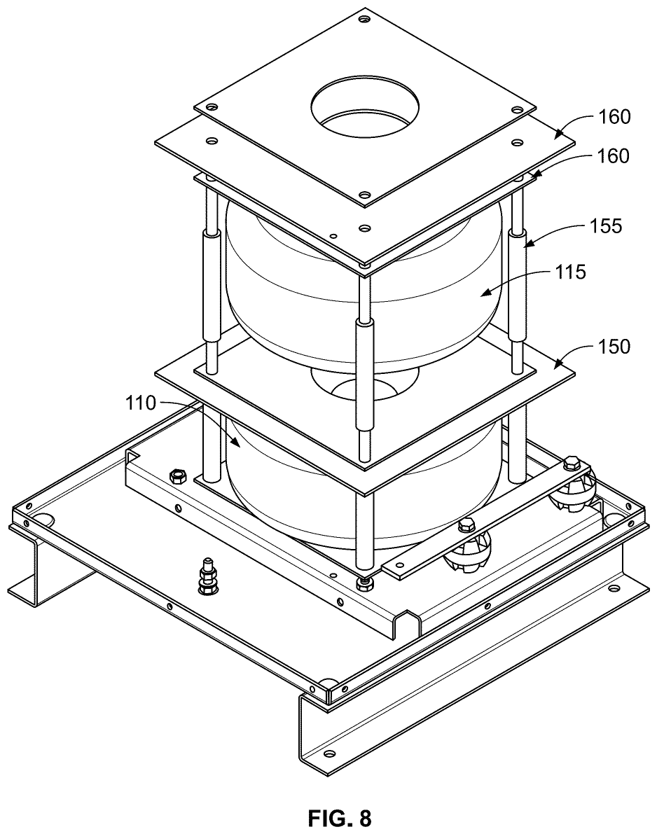

FIG. 7 illustrates an exploded view of the transformer 100 including the first phase transformer 110 according to some embodiments. As illustrated, a second base, or platform, 150 may be placed above the first phase transformer 110. As illustrated, in some embodiments, the second base 150 may be formed of one or more components. The second base 150 may be supported by one or more supports 155. As illustrated in FIG. 8, the second phase transformer 115 may then be located on the second base 150, such that the second phase transformer 115 is stacked upon the first phase transformer 110. The second phase transformer 115 may have a similar construction as the first phase transformer 110. For example, the second phase transformer 115 may a core 140 and a plurality of windings 145 wound around the core 140. As discussed above, in operation, the second phase transformer 115 is configured to receive the second phase of the three-phase voltage, and transform the second phase from the first voltage to the second voltage.

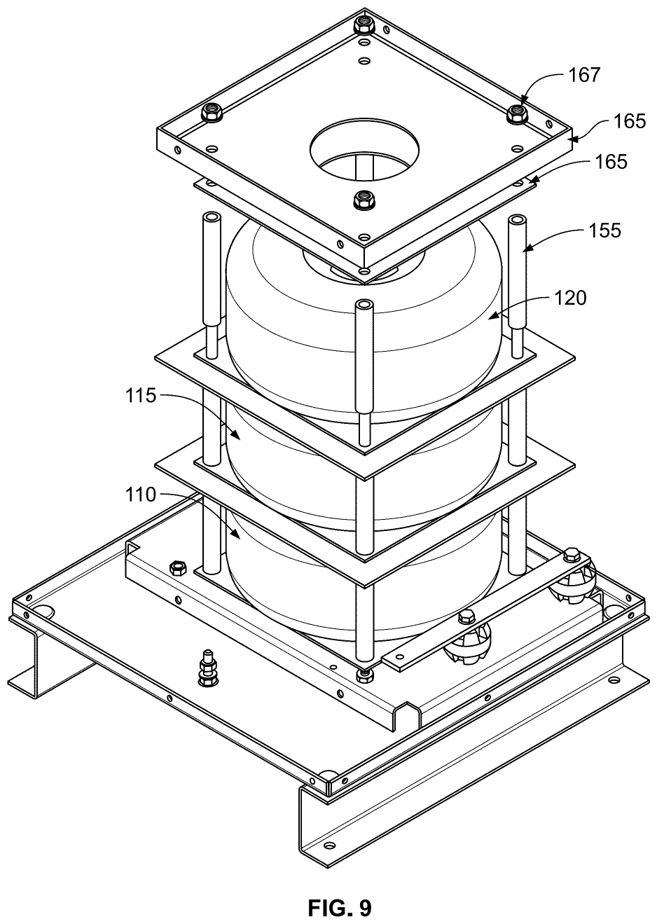

As further illustrated in FIG. 8, a third base, or platform, 160 may be placed above the second phase transformer 115. The third base 160 may also be supported by one or more supports 155. As illustrated in FIG. 9, the third phase transformer 120 may then be located on the third base 160, such that the third phase transformer 120 is stacked upon the second phase transformer 115 and the first phase transformer 110. As further illustrated in FIG. 9, a top, or cap, 165 may then be placed above the third phase transformer 120. As illustrated, in some embodiments, the cap 165 may be formed of one or more components. The cap 165 may be secured to the one or more supports 155 via one or more fasteners 167. As discussed above, in operation, the third phase transformer 120 is configured to receive the third phase of the three-phase voltage, and transform the third phase from the first voltage to the second voltage.

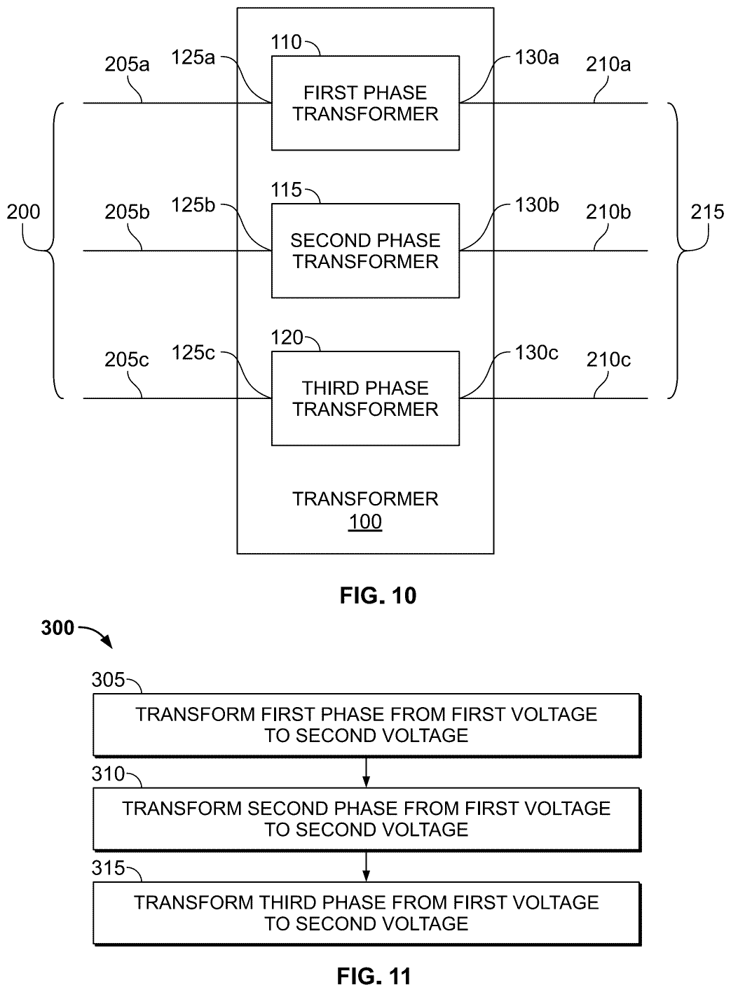

FIG. 10 is a block diagram illustrating the transformer 100 according to some embodiments. The transformer 100 is configured to receive an input three-phase voltage 200 having a first phase 205a, a second phase 205b, and a third phase 205c, at a first voltage level. The first phase 205a, at the first voltage level, is received by the first phase input 125a of the first phase transformer 110. The second phase 205b, at the first voltage level, is received by the second phase input 125b of the second phase transformer 115. The third phase 205c, at the first voltage, is received by the third phase input 125c of the third phase transformer 120. The first, second, and third phase transformers 110, 115, 120 transform each respective phase 205a-205c of the three-phase voltage 200 from the first voltage level to the second voltage level.

The transformed first phase 210a, at the second voltage level, is then output from the first phase output 130a of the first phase transformer 110. The transformed second phase 210b, at the second voltage level, is then output from the second phase output 130b of the second phase transformer 115. The transformed third phase 210c, at the second voltage level, is then output from the third phase output 130c of the third phase transformer 120. The transformer 100 outputs transformed three-phase voltage 215 having the transformed first, second, and first phases 210a-210c, at the second voltage.

FIG. 11 is a flowchart illustrating a process, or operation, 300 according to some embodiments. It should be understood that the order of the steps disclosed in operation 300 could vary. Although illustrated as occurring in parallel order, in other embodiments, the steps disclosed may be performed in serial order. Furthermore, additional steps may be added to the process and not all of the steps may be required. A first phase of a three-phase voltage is transformed, via a first phase transformer, from a first voltage to a second voltage (block 305). A second phase of the three-phase voltage is transformed, via a second phase transformer, from the first voltage to the second voltage (block 310). A third phase of the three-phase voltage is transformed, via a third phase transformer, from the first voltage to the second voltage (block 315).

Thus, the application provides, among other things, a three-phase voltage transformer. The three-phase voltage transformer meets Department of Energy and UL requirements while providing a relatively small and light transformer that may be mountable on a wall or a floor. Various features and advantages of the application are set forth in the following claims.

What is claimed is:

1. A three-phase transformer configured to transform a three-phase voltage, the transformer comprising:
a first toroidal transformer configured to transform a first phase of the three-phase voltage, the first toroidal transformer supposed by a first base;
a second toroidal transformer electrically connected to the first toroidal transformer, the second toroidal transformer configured to transform a second phase of the three-phase voltage, the second toroidal transformer supposed by a second base;
a third toroidal transformer electrically connected to the first toroidal transformer and the second toroidal transformer, the third toroidal transformer configured to transform a third phase of the three-phase voltage, the third toroidal transformer supposed by a third base; and
an input/output support that is linearly arranged along an axial direction of the first toroidal transformer, the second toroidal transformer, and the third toroidal transformer, the input/output support configured to support a first phase input and a first phase output of the first toroidal transformer, a second phase input and a second phase output of the second toroidal transformer, and a third phase input and a third phase output of the third toroidal transformer, wherein the input/output support contacts the first base, the second base, and the third base.

2. The three-phase transformer of claim 1, wherein the first toroidal transformer includes a first toroidal core.

3. The three-phase transformer of claim 2, wherein the first toroidal core is wound with magnetic wire.

4. The three-phase transformer of claim 3, wherein the magnetic wire is at least one selected from a group consisting of aluminum and copper.

5. The three-phase transformer of claim 4, wherein the at least one selected from the group consisting of aluminum and copper is film coated.

6. The three-phase transformer of claim 1, wherein the second toroidal transformer includes a second toroidal core.

7. The three-phase transformer of claim 6, wherein the second toroidal core is wound with magnetic wire.

8. The three-phase transformer of claim 7, wherein the magnetic wire is at least one selected from a group consisting of aluminum and copper.

9. The three-phase transformer of claim 8, wherein the at least one selected from the group consisting of aluminum and copper is film coated.

10. The three-phase transformer of claim 1, wherein the third toroidal transformer includes a third toroidal core.

11. The three-phase transformer of claim 10, wherein the third toroidal core is wound with magnetic wire.

12. The three-phase transformer of claim 11, wherein the magnetic wire is at least one selected from a group consisting of aluminum and copper.

13. The three-phase transformer of claim 12, wherein the at least one selected from the group consisting of aluminum and copper is film coated.

14. The three-phase transformer of claim 1, wherein the first toroidal transformer, the second toroidal transformer, and the third toroidal transformer are enclosed within a single housing.

15. A method of transforming a three-phase voltage, the method comprising:
transforming, via a first toroidal transformer, a first phase of the three-phase voltage, wherein the first toroidal transformer is supported by a first base;
transforming, via a second toroidal transformer electrically connected to the first toroidal transformer, a second phase of the three-phase voltage, wherein the second toroidal transformer is supported by a second base; and
transforming, via a third toroidal transformer electrically connected to the first toroidal transformer and the second toroidal transformer, a third phase of the three-phase voltage, wherein the third toroidal transformer is supported by a third base.
linearly arranging an input/output support along an axial direction of the first toroidal transformer, the second toroidal transformer, and the third toroidal transformer, the input/output support configured to support a first phase input and a first phase output of the first toroidal transformer, a second phase input and a second phase output of the second toroidal transformer, and a third phase input and a third phase output of the third toroidal transformer, wherein the input/output support contacts the first base, the second base, and the third base.

16. The method of claim 15, wherein the first toroidal transformer, the second toroidal transformer, and the third toroidal transformer each include a toroidal core.

17. The method of claim 16, further comprising:
wrapping each toroidal core with a magnetic wire.

18. The method of claim 17, wherein the magnetic wire is at least one selected from a group consisting of aluminum and copper.

19. The method of claim 18, wherein the at least one selected from the group consisting of aluminum and copper is film coated.

20. The method of claim 15, further comprising:
enclosing the first toroidal transformer, the second toroidal transformer, and the third toroidal transformer in a single housing.
